(19) United States
(12) Patent Application Publication
(10) Pub. No.: US 2012/0295098 A1
(43) Pub. Date: Nov. 22, 2012

(54) FIXED-ARRAY ANISOTROPIC CONDUCTIVE FILM USING SURFACE MODIFIED CONDUCTIVE PARTICLES

(75) Inventors: Jiunn-Jye Hwang, New Taipei City (TW); Jiannrong Lee, Webster, NY (US); Shuji Rokutanda, Fremont, CA (US); Chin-Jen Tseng, Fremont, CA (US); Rong-Chang Liang, Cupertino, CA (US)

(73) Assignee: TRILLION SCIENCE, INC., Fremont, CA (US)

(21) Appl. No.: 13/111,300

(22) Filed: May 19, 2011

(51) Int. Cl. B32B 5/16; B32B 5/00; B32B 7/12

(52) U.S. Cl. 428/328; 428/221; 428/335; 428/323

(57) ABSTRACT

Structures and manufacturing processes of an ACF array and more particularly a non-random array of microcavities of predetermined configuration, shape and dimension. The manufacturing process includes fluidic filling of conductive particles surface-treated with a coupling agent onto a substrate or carrier web comprising a predetermined array of microcavities. The thus prepared filled conductive microcavity array is then over-coated or laminated with an adhesive film, the conductive particles are transferred to the adhesive film such that they are only partially embedded in the film.

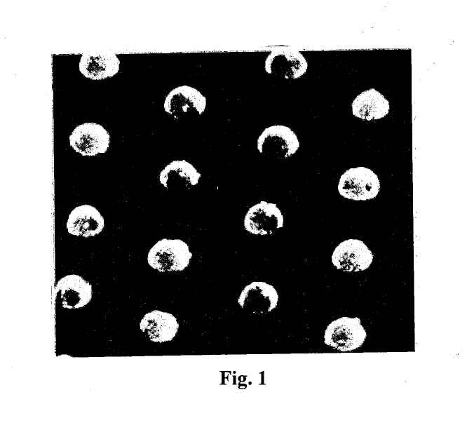

### BACKGROUND

1. Field

This invention relates generally to structures and manufacturing methods for anisotropic conductive films (ACF). More particularly, this invention relates to structures and manufacturing processes for an ACF having improved reliability of electrical connections in which the conductive particles are only partially embedded in the ACF thereby making them readily accessible for bonding to an electronic device. Still more particularly, it relates to ACF that utilize conductive particles that are treated with a coupling agent such that they can be bonded to and only partially embedded in an adhesive film in a non-random array.

2. Description of the Related Art

Anisotropic Conductive Film (ACF) is commonly used in flat panel display driver integrated circuit (IC) bonding. A typical ACF bonding process comprises a first step in which the ACF is attached onto the electrodes of the panel glass; a second step in which the driver IC bonding pads are aligned with the panel electrodes; and a third step in which pressure and heat are applied to the bonding pads to melt and cure the ACF within seconds. The conductive particles of the ACF provide anisotropic electrical conductivity between the panel electrodes and the driver IC. Lately, ACF has also been used widely in applications such as flip chip bonding and photovoltaic module assembly.

The conductive particles of a traditional ACF are typically randomly dispersed in the ACF. There is a limitation on the particle density of such a dispersion system due to X-Y conductivity. In a fine pitch bonding application, the conductive particles density must be high enough to have an adequate number of conductive particles bonded on each bonding pad. However, the probability of a short circuit or undesirable high-conductivity in the insulating area between two bonding pads also increases due to the high density conductive particles and the characteristics of random dispersion.

U.S. Published Application 2010/0101700 to Liang et al. discloses a technique which overcomes some of the shortcomings of ACF having randomly dispersed conductive particles. Liang discloses that conductive particles are arranged in pre-determined array patterns in fixed-array ACF (FACF). In one embodiment, a microcavity array may be formed directly on a carrier web or on a cavity-forming layer pre-coated on the carrier web and the distance between the particles are predefined and well-controlled for example, by a laser ablation process, by an embossing process, by a stamping process, or by a lithographic process. Such a non-random array of conductive particles is capable of ultra fine pitch bonding without the likelihood of short circuit. It also provides uniform contact resistance since the number of particles on each bonding pad is precisely controlled. In one embodiment, the particles may be partially embedded in the adhesive film forming the ACF. The uniformity of contact resistance or impedance is becoming very critical in the advanced high resolution video rate flat panels, and the fixed-array ACF clearly demonstrated its advantages in such applications.

### SUMMARY OF THE DISCLOSURE

This disclosure improves the fixed-array ACF of Liang by providing an ACF in which the conductive particles are coated with a coupling agent. In one embodiment, the conductive particles can be partially embedded in the adhesive resin such that at least a portion of the surface is not covered by the adhesive. In one embodiment, the particles are embedded to a depth of about one-third to three-fourths their diameter. In one particular embodiment, the conductive particles are coated with a silane coupling agent. In a more particular embodiment, the coupling agent includes a thiol or a disulfide or tetrasulfide moiety for bonding the coupling agent to the surface of the conductive particle.

Conventionally, the conductive particles used in ACFs are coated with a layer of insulative polymer to reduce the tendency for the particle surfaces to touch and cause an electrical short to occur in the x-y plane. However, this insulative layer complicates the assembly of the ACF because, in order to achieve Z-direction conductivity, the insulative layer on the surface of the conductive particle must be displaced. This increases the amount of pressure that must be applied to the ACF (for example from a pressure bar) to achieve electrical contact between the glass (COG) or film (COF) substrate and the chip device. However, when the conductive particle is only partially embedded in the adhesive layer, substantially less pressure is required to achieve bonding and lower electrode resistance may be obtained.

In accordance with one embodiment, by treating the conductive particle with a coupling agent, a monolayer coating is achievable which facilitates achieving contact between the electrical component (e.g., integrated circuit (IC)) with substantially less pressure. Consequently, the probability of short circuits can be reduced. At the same time, the coupling agent on particle surface significantly improves the dispersibility of the particles in the adhesive filled in the non-contact area or the spacing among electrodes and reduces the probability of particle aggregation therein. Consequently, the probability of short circuits in the X-Y plane can be reduced.

### BRIEF DESCRIPTION OF THE DRAWING

The Figure is an SEM photograph of an ACF from a tilt angle of 60° showing the conductive particles partially embedded in the ACF adhesive.

### DETAILED DESCRIPTION

U.S. Published Application 2010/0101700 to Liang et al. is incorporated herein in its entirety by reference.

Any of the conductive particles previously taught for use in ACFs may be used in practicing this disclosure. Gold coated particles are used in one embodiment. In one embodiment, the conductive particles have a narrow particle size distribution with a standard deviation of less than 10%, preferably less than 5%, even more preferably less than 3%. The particle size is preferably in the range of about 1 to 250 μm, more preferably about 2-50 μm, even more preferably about 3-10 μm. In another embodiment the conductive particles have a bimodal or a multimodal distribution. In another embodiment, the conductive particles have a so called spiky surface. The size of the microcavities and the conductive particles are selected so that each microcavity has a limited space to contain only one conductive particle. To facilitate particle filling and transferring, a microcavity having a tilted wall with a wider top opening than the bottom may be employed.

In one embodiment, conductive particles including a polymeric core and a metallic shell are used. Useful polymeric cores include but are not limited to, polystyrene, polyacrylates, polymethacrylates, polyvinyls, epoxy resins, polyurethanes, polyamides, phenolics, polydienes, polyolefins, aminoplastics such as melamine formaldehyde, urea formaldehyde, benzoguanamine formaldehyde and their oligomers, copolymers, blends or composites. If a composite material is used as the core, nanoparticles or nanotubes of carbon, silica, alumina, BN, TiO₂ and clay are preferred as the filler in the core. Suitable materials for the metallic shell include, but are not limited to, Au, Pt, Ag, Cu, Fe, Ni, Sn, Al, Mg and their alloys. Conductive particles having interpenetrating metal shells such as Ni/Au, Ag/Au, Ni/Ag/Au are useful for hardness, conductivity and corrosion resistance. Particles having rigid spikes such as Ni, carbon, graphite are useful in improving the reliability in connecting electrodes susceptible to corrosion by penetrating into the corrosive film if present. Such particles are available from Sekisui KK (Japan) under the trade name MICROPEARL, Nippon Chemical Industrial Co., (Japan) under the trade name BRIGHT, and Dyno A.S. (Norway) under the trade name DYNOSPHERES.

The spike might be formed by doping or depositing small foreign particles such as silica on the latex particles before the step of electroless plating of Ni followed by partial replacement of the Ni layer by Au.

Narrowly dispersed polymer particles may be prepared by, for example, seed emulsion polymerization as taught in U.S. Pat. Nos. 4,247,234, 4,877,761, 5,216,065 and the Ugelstad swollen particle process as described in Adv., Colloid Interface Sci., 13, 101 (1980); J. Polym. Sci., 72, 225 (1985) and “Future Directions in Polymer Colloids”, ed. El-Aasser and Fitch, p. 355 (1987), Martinus Nijhoff Publisher. In one embodiment, monodispersed polystyrene latex particle of about 5 μm diameter is used as a deformable elastic core. The particle is first treated in methanol under mild agitation to remove excess surfactant and to create microporous surfaces on the polystyrene latex particles. The thus treated particles are then activated in a solution comprising PdCl₂, HCl and SnCl₂ followed by washing and filtration with water to remove the Sn⁴⁺ and then immersed in an electroless Ni plating solution (from for example, Surface Technology Inc, Trenton, N.J.) comprising a Ni complex and hydrophosphite at 90° C. for about 30 to about 50 minutes. The thickness of the Ni plating is controlled by the plating solution concentration and the plating temperature and time.

In one embodiment, the conductive particles are formed with spikes. These spikes may be formed as, without limitation, sharpened spikes, nodular, notches, wedges, or grooves. The microcavity may comprise more than one spike with different orientations. The number, size, shape and orientation of the spikes in each microcavity are predetermined but may be varied from cavity to cavity. The microcavities with spike substructures may be manufactured by photolithography or microembossing using a shim or mold prepared, for example, by direct diamond turning, by laser engraving, or by photolithography followed by electroforming.

To improve the rigidity of the spike, a rigid filler may be filled into the spike cavities after the metallization step. Useful rigid fillers include, but are not limited to, silica, TiO₂, zirconium oxide, ferric oxide, aluminum oxide, carbon, graphite, Ni, and their blends, composites, alloys, nanoparticles or nanotubes. If the metallization step (a) is accomplished by electroplating, electroless plating, or electrodeposition, the rigid filler may be added during the metallization process. Useful deformable core materials for the step (b) include, but are not limited to, polymeric materials such as polystyrene, polyacrylates, polymethacrylates, polyolefins, polydienes, polyurethanes, polyamides, polycarbonates, polyethers, polyesters, phenolics, aminoplastics, benzoguanamines, and their monomers, oligomers, copolymers, blends or composites. They may be filled into the microcavities in the form of solutions, dispersions, or emulsions. Inorganic or metallic fillers may be added to the core to achieve optimum physicomechanical and rheological properties. The surface tension of the core material and the conductive shell of the microcavity and the skirt edge may be adjusted so that the core material form a bump shape after the filling and the subsequent drying process. An expanding agent or a blowing agent may be used to facilitate the formation of the bump shape core. Alternatively, the core materials may be filled in on-demand by for example, an inkjet printing process. The adhesive layer may be alternatively applied directly onto the array by coating, spraying or printing. The coated array may be used as the ACF or further laminated with a release substrate to form the sandwich ACF.

The release layer may be selected from the list comprising fluoropolymers or oligomers, silicone oil, fluorosilicones, polyolefines, waxes, poly(ethyleneoxide), poly(propyleneoxide), surfactants with a long-chain hydrophobic block or branch, or their copolymers or blends. The release layer is applied to the microcavity array by methods including, but are not limited to, coating, printing, spraying, vapor deposition, plasma polymerization or cross-linking In another preferred embodiment, the method further includes a step of employing a close loop of microcavity array. In another preferred embodiment, the method further includes a step of employing a cleaning device to remove residual adhesive or particles from the microcavity array after the particle transfer step. In a different embodiment, the method further includes a step of applying a release layer onto the microcavity array before the particle filling step.

In accordance with one embodiment, the conductive particles are treated/coated with a coupling agent. The coupling agent enhances corrosion resistance of the conductive particles as well as the wet adhesion, or the binding strength in humid conditions, of the particles to electrodes having metal-OH or metal oxide moiety on the electrode surface, so that the conductive particles can be only partially embedded in the adhesive, such that they are readily accessible for bonding the electrical device. More importantly, the surface treated conductive particles can be better dispersed with a reduced risk of aggregation in the adhesive of the non-contact area or the spacing area among electrodes. As a result, the risk of short circuit in the X-Y plane is significantly reduced, particularly in the fine pitch applications.

Examples of useful coupling agents to pre-treat the conductive particles include titanate, zirconate and silane coupling agents (“SCA”) such as organotrialkoxysilanes including 3-glycidoxpropyltrimethoxy-silane, 2-(3,4-epoxycyclohexyl)ethyltrimethoxysilane, gamma-mercaptopropyltrimethoxysilane, bis(3-triethoxysilylpropyl)tetrasulfide and bis(3-triethoxysilylpropyl)disulfide. The coupling agents containing thiol, disulfide,and tetrasulfide functional groups are particularly useful to pre-treat Au particles due to the formation of Au—S bond even in mild reaction conditions (See for example, J. Am. Chem. Soc., 105 4481 (1983) Adsorption of Bifunctional Organic Disulfides on Gold Surfaces.) The coupling agent may be applied to the surface of the conductive particle in an amount of about 5% to 100% of surface coverage, more particularly about 20% to 100% of surface coverage, even more particularly, 50% to 100% of surface coverage [For references, see J. Materials Sci., Lett., 8 99], 1040 (1989); Langmuir, 9 (11), 2965-2973 (1993); Thin Solid Films, 242 (1-2), 142 (1994); Polymer Composites, 19 (6), 741 (1997); and “Silane Coupling Agents”, 2^{nd} Ed., by E. P. Plueddemann, Plenum Press, (1991) and references therein]. While not desiring to be bound by this particular theory, the reactions of the sulfur containing coupling agent appear to be:

(RO)3Si—R′—SH+Au→(RO)3Si—R′—S—Au

(RO)3Si—R′—SS—R″+Au→(RO)3SiR′S—Au+R″S—Au

After the reaction, the particle surface is covered by a monolayer of (RO)3Si—S— group and sometimes with additional R″S— group. Both help the Au particles disperse well into the adhesive upon heating and pressure during the bonding process and prevent the particles from forming aggregations or clusters. In the presence of trace amount of water, the —SiOR is hydrolyze to —SiOH and react with the metal oxide or metal hydroxide on the electrode surface bonded by the adhesive to form Si—O-Metal or more exactly, Au—R′—Si—O-Metal bonding which is more durable and environmental resistant.

The microcavity array may be formed directly on a carrier web or on a cavity-forming layer pre-coated on the carrier web. Suitable materials for the web include, but are not limited to polyesters such as polyethylene terephthalate (PET) and polyethylene naphthalate (PEN), polycarbonate, polyamides, polyacrylates, polysulfone, polyethers, polyimides, and liquid crystalline polymers and their blends, composites, laminates or sandwich films. A suitable material for the cavity-forming layer can include, without limitation, a thermoplastic material, a thermoset material or its precursor, a positive or a negative photoresist, or an inorganic material. To achieve a high yield of particle transfer, the carrier web may be preferably treated with a thin layer of release material to reduce the adhesion between the microcavity carrier web and the adhesive layer. The release layer may be applied by coating, printing, spraying, vapor deposition, thermal transfer, or plasma polymerization/crosslinking either before or after the microcavity-forming step. Suitable materials for the release layer include, but are not limited to, fluoropolymers or oligomers, silicone oil, fluorosilicones, polyolefines, waxes, poly(ethyleneoxide), poly(propyleneoxide), surfactants with a long-chain hydrophobic block or branch, or their copolymers or blends.

In one embodiment, particle deposition may be effected by applying a fluidic particle distribution and entrapping process, in which each conductive particle is entrapped into one microcavity. A number of entrapping processes can be used. For example, in one embodiment disclosed in the Liang Publication, a novel roll-to-roll continuous fluidic particle distribution process can be used to entrap only one conductive particle into each microcavity. The entrapped particles then can be transferred from the microcavity array to predefined locations on an adhesive layer. Typically, the distance between these transferred conductive particles must be greater than the percolation threshold, which is the density threshold at which the conductive particles aggregate. In general, the percolation threshold corresponds to the structure of the microcavity array structure and to the plurality of conductive particles.

A non-random ACF array that may include more than one set of microcavities either on the same or opposite side of the adhesive layer, with the microcavities typically having predetermined size and shape. In one particular embodiment, the microcavities on the same side of the adhesive film have substantially same height in the z-direction (the thickness direction). In another embodiment, the microcavities on the same side of the adhesive film have substantially same size and shape. The ACF may have more than one set of microcavities even on the same side of the adhesive as long as their height in the vertical direction is substantially the same to assure good connection in the specific applications of the ACF. The microcavities may be substantially on one side of the anisotropic conductive adhesive film.

### Surface Treatment of the Temporary Microcavity Carrier

A microcavity array containing microcavities of about 6 μm (diameter) by about 4 μm (depth) by about 3 μm (partition) was prepared by laser ablation on an approximately 3 mil heat-stabilized polyimide film (PI, from Du Pont) to form the microcavity carrier.

Particle Filling into Microcavity Array

An exemplary step-by-step procedure for particle filling is as follows: The surface treated PI microcavity array web was coated with a large amount of a conductive particle dispersion using a smooth rod. More than one filling may be employed to assure no unfilled microcavities. The filled microcavity array was allowed to dry at about room temperature for about 1 min, and the excess particles were wiped off gently by for example a rubber wiper or a soft lint-free cloth soaked with acetone solvent. Microscope images of the filled microcavity array were analyzed by ImageTool 3.0 software. A filling yield of more than about 99% was observed for all the microcavity arrays evaluated regardless of the type of surface treatment. The particle density may be varied by using different design of microcavity array. Alternatively, the particle density may be adjusted conveniently by changing the degree of filling through either the concentration of the conductive particle dispersion or by the number of passes in the filling process.

Transferring the Particles from the Microcavity Carrier to the Adhesive Layer

Two exemplary step-by-step procedures for particle transfer are as follows:

Nickel particles: Adopting the particle filling procedure described in the above example, a surface-treated polyimide microcavity sheet with a 6.times.2.times.4 μm array configuration was filled with about 4 μm Umicore Ni particles. The attained percentage of particle filling was typically >about 99%. An epoxy film was prepared with about 15 μm target thickness. The microcavity sheet and the epoxy film were affixed, face to face, on a steel plate. The steel plate was pushed through a HRL 4200 Dry-Film Roll Laminator, commercially available from Think & Tinker. The lamination pressure was set at a pressure of about 6 lb/in (about 0.423 g/cm2) and a lamination speed of about 2.5 cm/min. Particles were transferred from PI microcavity to epoxy film with an efficiency >about 98%. Acceptable tackiness during prebond at about 70.degree. C. and conductivity after main bond at about 170.degree. C. was observed after the resultant ACF film was bonded between two electrodes using a Cherusal bonder (Model TM-101P-MKIII.)

Gold particles: Similarly, a surface-treated polyimide microcavity sheet with an approximately 6×2×4 μm array configuration was filled with monodispersed 4 μm Au particles. The attained percentage of particle filling was also greater than about 99%. An epoxy film was prepared using a #32 wire bar with a targeted thickness of about 20 μm. Both were placed on a steel plate face-to-face. The microcavity sheet and the epoxy film were affixed, face to face, on a steel plate. The steel plate was pushed through a HRL 4200 Dry-Film Roll Laminator, commercially available from Think & Tinker. The lamination pressure was set at a pressure of about 6 lb/in (or about 0.423 g/cm2) and a lamination speed of about 2.5 cm/min. An excellent particle transfer efficiency (greater than about 98%) was observed. The resultant ACF films showed acceptable tackiness and conductivity after bonded between two electrodes by the Cherusal bonder (Model TM-101P-MKIII.)

In another embodiment, the microcavities further comprise a substructure within the microcavity. In another preferred embodiment, the sub-structure is a form of spike, notch, groove, and nodule. In another preferred embodiment, the sub-structure is filled with a rigid, electrically conductive composition before the step of depositing or coating an electrically conductive layer onto selective areas of the microcavity array. In another preferred embodiment, the rigid, electrically conductive composition comprises a metal or carbon or graphite particle or tube. In another preferred embodiment, the metal particle is a metal nano particle. In another preferred embodiment, the metal particle is a nickel nano particle. In another preferred embodiment, the electrically conductive particle further includes carbon nano particle or carbon nano tube.

The adhesives used in the ACF may be thermoplastic, thermoset, or their precursors. Useful adhesives include but are limited to pressure sensitive adhesives, hot melt adhesives, heat or radiation curable adhesives. The adhesives may comprise for examples, epoxide, phenolic resin, amine-formaldehyde resin, polybenzoxazine, polyurethane, cyanate esters, acrylics, acrylates, methacrylates, vinyl polymers, rubbers such as poly (styrene-co-butadiene) and their block copolymers, polyolefins, polyesters, unsaturated polyesters, vinyl esters, polycaprolactone, polyethers, and polyamides. Epoxide, cyanate esters and multifunctional acrylates are particularly useful. Catalysts or curing agents including latent curing agents may be used to control the curing kinetics of the adhesive. Useful curing agents for epoxy resins include, but are not limited to, dicyanodiamide (DICY), adipic dihydrazide, 2-methylimidazole and its encapsulated products such as Novacure HX dispersions in liquid bisphenol A epoxy from Asahi Chemical Industry, amines such as ethylene diamine, diethylene triamine, triethylene tetraamine, BF3 amine adduct, Amicure from Ajinomoto Co., Inc, sulfonium salts such as diaminodiphenylsulphone, p-hydroxyphenyl benzyl methyl sulphonium hexafluoroantimonate. Coupling agents including, but are not limited to, titanate, zirconate and silane coupling agents such as glycidoxypropyl trimethoxysilane and 3-aminopropyl trimethoxy-silane may also be used to improve the durability of the ACF. The effect of curing agents and coupling agents on the performance of epoxy-based ACFs can be found in S. Asai, et al, J. Appl. Polym. Sci., 56, 769 (1995). The entire paper is hereby incorporated by reference in its entirety.

Fluidic assembly of IC chips or solder balls into recess areas or holes of a substrate or web of a display material has been disclosed in for example, U.S. Pat. Nos. 6,274,508, 6,281,038, 6,555,408, 6,566,744 and 6,683,663. Filling and top-sealing of electrophoretic or liquid crystal fluids into the microcups of an embossed web is disclosed in for example, U.S. Pat. Nos. 6,672,921, 6,751,008, 6,784,953, 6,788,452, and 6,833,943. Preparation of abrasive articles having precise spacing by filling into the recesses of an embossed carrier web, an abrasive composite slurry comprising a plurality of abrasive particles dispersed in a hardenable binder precursor was also disclosed in for example, U.S. Pat. Nos. 5,437,754, 5,820,450 and 5,219,462. All of the aforementioned United States Patents are hereby incorporated by reference in their respective entirety. In the above-mentioned art, recesses, holes, or microcups were formed on a substrate by for example, embossing, stamping, or lithographic processes. A variety of devices were then filling into the recesses or holes for various applications including active matrix thin film transistors (AM TFT), ball grid arrays (BGA), electrophoretic and liquid crystal displays. In a particular embodiment an ACF is formed by fluidic filling of only one conductive particle in each microcavity or recess and the conductive particles comprising a polymeric core and a metallic shell and the metallic shell is coated with a coupling agent and more particularly a silane coupling agent and the particle is partially embedded in the ACF adhesive layer.

The microcavities may be formed directly on a plastic web substrate with, or without, an additional cavity-forming layer. Alternatively, the microcavities may also be formed without an embossing mold, for example, by laser ablation or by a lithographic process using a photoresist, followed by development, and optionally, an etching or electroforming step. Suitable materials for the cavity forming layer can include, without limitation, a thermoplastic, a thermoset or its precursor, a positive or a negative photoresist, or an inorganic or a metallic material. As to laser ablating, one embodiment generates a laser beam for ablation having power in the range of between about 0.1 W/cm² to about 200 W/cm² employing a pulsing frequency being between about 0.1 Hz to about 500 Hz; and applying between about 1 pulse to about 100 pulses. In a preferred embodiment, laser ablation power is in the range of between about 1 W/cm² to about 100 W/cm², employing a pulsing frequency of between about 1 Hz to about 100 Hz, and using between about 10 pulses to about 50 pulses. It also is desirable to apply a carrier gas with vacuum, to remove debris.

To enhance transfer efficiency, the diameter of the conductive particles and the diameter of the cavities have specific tolerance. To achieve a high transfer rate, the diameter of the cavities should have specific tolerance less than about 5% to about 10% standard deviation requirement is based on the rationales set forth in U.S. Patent Publication 2010/0101700.

In a further embodiment, the non-random ACF microarray can be provided in a unimodal implementation, in a bimodal implementation, or in a multimodal implementation. In an embodiment of a unimodal particle implementation, particles in a non-random ACF microcavity array can have a particle size range distributed about a single mean particle size value, typically between about 2 μm to about 6 μm, with embodiments featuring a narrow distribution including a narrow particle size distribution having a standard deviation of less than about 10% from the mean particle size. In other embodiments featuring a narrow distribution, a narrow particle size distribution may be preferred to have a standard deviation of less than about 5% from the mean particle size. Typically, a cavity of a selected cavity size is formed to accommodate a particle having a selected particle size that is approximately the same as the selected cavity size.

Thus, in a unimodal cavity implementation, microcavities in a non-random ACF microcavity array can have a cavity size range distributed about a single mean cavity size value, typically between about 2 μm to about 6 μm, with embodiments featuring a narrow distribution including a narrow cavity size distribution having a standard deviation of less than 10% from the mean cavity size. In other embodiments featuring a narrow distribution, a narrow cavity size distribution may be preferred to have a standard deviation of less than 5% from the mean cavity size.

In a bimodal particle implementation of a non-random ACF microcavity array, ACF particles can have two ACF particle size ranges, with each ACF particle type having a corresponding mean ACF particle size value, with a first mean ACF particle size being different from a second mean ACF particle size. Typically, each mean ACF particle size can be between about 2 μm to about 6 μm. In some embodiments of a bimodal particle implementation, each mode corresponding to respective mean ACF particle size values may have a corresponding narrow particle size distribution. In some selected embodiments, a narrow particle size distribution can be characterized by having a standard deviation of less than 10% from the mean particle size. In other selected embodiments, a narrow particle size distribution can be characterized by having a standard deviation of less than 5% from the mean particle size.

In one non-limiting example of a bimodal ACF particle implementation, a first ACF particle type may be selected to have a first mean particle size of about 3 μm, and a first ACF particle distribution having a standard deviation of about 10% from the first mean ACF particle size. A second ACF particle type, different from the first particle type, may be selected to have a second mean particle size of about 5 μm, and a second ACF particle distribution having a standard deviation of about 5% from the second mean ACF particle size. In another non-limiting example of a bimodal ACF particle implementation, a first ACF particle type can be electrically conductive, which has a corresponding first mean ACF particle size and a first ACF particle distribution, and a second ACF particle type can be electrically non-conductive but thermally conductive; which has a corresponding second mean ACF particle size and a second ACF particle distribution. Typically, a bimodal ACF microcavity array can be formed having a first mean ACF cavity size and a first ACF cavity distribution to accommodate the first ACF particle type; and having a second mean ACF cavity size and a second ACF cavity distribution to accommodate the second ACF particle type.

In a bimodal cavity implementation of a non-random ACF microcavity array, ACF microcavities can have two ACF cavity size ranges, with each ACF cavity type having a corresponding mean ACF cavity size value, with a first mean ACF cavity size being different from a second mean ACF cavity size. Typically, each mean ACF particle size can be between about 2 μm to about 6 μm. In some embodiments of a bimodal cavity implementation, each mode corresponding to respective mean ACF cavity size values may have a corresponding narrow ACF cavity size distribution. In some selected embodiments, a narrow ACF cavity size distribution can be characterized by having a standard deviation of less than 10% from the mean ACF cavity size. In other selected embodiments, a narrow ACF cavity size distribution can be characterized by having a standard deviation of less than 5% from the mean ACF cavity size.

In a multimodal non-random ACF microcavity array, three or more ACF cavity types can be provided, with each respective ACF cavity type having a different ACF cavity size from another, with respective mean ACF cavity sizes ranging from about 1 μm to about 10 μm. Typically, each ACF cavity type (and, by extension, ACF mean cavity size) in a multimodal ACF microcavity array can be provided in a respective wide ACF cavity size distribution, for example, having a standard deviation of less than 20% of the respective mean cavity size. In some embodiments employing a multimodal distribution, one or more of the mean ACF cavity sizes may have a corresponding narrow ACF cavity size distribution, such as, without limitation, having a standard deviation of less than 10% of the respective mean ACF cavity size or having a standard deviation of less than 5% of the respective mean ACF cavity size.

Furthermore, in light of all of the foregoing, this invention additionally discloses the use of diverse non-random ACF particles, which particles may vary in one, or more, of shape, structure, physical characteristics, or composition, for each respective mode (with each mode being representative of an ACF particle size). Each mode correspond to one ACF particle type and mean ACF particle size. In general, different ACF particle types may differ, respectively, in one or more of: particle composition, particle shape, particle surface asperity type or distribution, or in an electrical, a thermal, a chemical, or a mechanical property of an ACF particle. Similarly, different ACF cavity types may differ, respectively, in one or more of: cavity shape, cavity surface asperity type or distribution, or in an electrical, a thermal, a chemical, or a mechanical property of material in which an ACF cavity is formed. An “asperity” in this context means a relatively localized projection on the surface of the particle or of the cavity.

In an embodiment of a fabrication process for a multimodal non-random ACF microcavity array, particles may be selected to provide a first ACF particle type having a first mean ACF particle size with a first ACF particle distribution, a second ACF particle type having a second mean ACF particle size with a second ACF particle distribution, and a third ACF particle type having a third mean ACF particle size with a third ACF particle distribution. In this example, the second ACF particle type has a larger mean ACF particle size than the first ACF particle type, and the third ACF particle type has a larger mean ACF particle size than the second ACF particle type. To manufacture such multimodal non-random ACF array, a multimodal microcavity array may be formed by selectively forming on an ACF microcavity array substrate to receive the aforementioned three ACF particle types, a first cavity type having a first mean ACF cavity size, a second cavity type having a second mean ACF cavity size, and a third cavity type having a third mean ACF cavity size. One method of manufacture can include applying the larger, third-type ACF particles to the microcavity array, followed by applying the intermediate, second-type ACF particles to the microcavity array, followed by applying the smaller, first-type ACF particles to the multimodal ACF microcavity array. The ACF particles may be applied using one or more of the aforementioned array-forming techniques.

In a specific embodiment, the invention further discloses a method for fabricating an electric device. The method includes a step of placing a plurality of electrically conductive particles that include an electrically conductive shell surface-treated with a coupling agent and a core material into an array of microcavities followed by overcoating or laminating an adhesive layer onto the filled microcavities. In a one embodiment, the step of placing a plurality of surface treated conductive particles into an array of microcavities comprises a step of employing a fluidic particle distribution process to entrap each of the conductive particles into a single microcavity. In another preferred embodiment, the method further includes a step of depositing or coating an electrically conductive layer on selective areas of an array of microcavities followed by filling the coated microcavities with a deformable composition and forming a conductive shell around the microcavities. In one embodiment, the top conductive layer shell is electrically connected to the conductive layer on the microcavities.

The depth of the microcavity is important in the processes of filling and of transferring conductive particles and partially embedding the conductive particles in the adhesive layer. With a deep cavity (relative to the size of the conductive particles), it's easier to keep the particle in the cavity before transfer to the epoxy layer; however, it's more difficult to transfer the particles. With a shallow cavity, it's easier to transfer the particle to the adhesive layer; however, it's more difficult to keep the particles that are filled in the cavity before the transfer of the particles.

The invention is illustrated in more detail by the following non-limiting example. Two types of commercially available conductive particles were used in the examples: the Ni/Au particles from Nippon Chemical through its distributor, JCI USA, in New York, a subsidiary of Nippon Chemical Industrial Co., Ltd., White Plains, N.Y. and the Ni particles from Inco Special Products, Wyckoff, N.J.

### EXAMPLE 1

### Preparation of SCA Treated Conductive Particle

Weigh 12 g of a Au particle into a 1 L reaction kettle. Add 226 g of Isopropyl Alcohol (IPA) to provide about 5wt % of Au in IPA. Add 12 g of gamma-mercapto-propyltrimethoxysilane into the Au dispersion in IPA. Close the kettle and apply ultrasonication for 30 min. After completed, the mixture was stirring 12˜24 hours under room temperature. The Au particle was allowed to settle and rinsed to remove excess solvent. The rinsing process is repeated until no unreacted coupling agent in the rinsing solvent can be detected by thin layer chromatography. Essentially, the entire surface of the particles was coated with the coupling agent (100% coverage).

### Preparation of the Adhesive Layer

13 grams of phenoxy resin PKFE (from InChem Rez), 2 grams of PKCP-80 (from InChem Rez) and 1 gram of M52N (from Arkema, Philadelphia) were added to 40 grams of ethyl acetate. The solution was heated at 70° C. and mixed with stirring until all the phenoxy resins are well-dispersed. 1.5 grams of Pararoid EXL-2314 (from Rohm and Haas), 0.2 grams of Silquest A187 (from Momentive Performance Material), 0.5 grams Ti-Pure R706 (from DuPont) and 12 grams of ethyl acetate were added into the above phenoxy solution and mixed until a homogeneous dispersion is achieved.

28 grams of latent hardener HXA3932HP (microencapsuled imidazole epoxy adduct, from Asahi Chemicals, Japan) were added into the stock solution and coated onto a 2 mil release liner (UV50, from CPFilms) to form the adhesive layer having a thickness ranging from 10 to 20 μm. Conductive gold particles were filled into a microcavity web having a microcavity array of 5 μm (diameter)×7 μm (partition)×4 μm (depth) and transferred onto the adhesive layer as described in US Patent Applications 2006/0280912, 2009/0053859 and 2010/0101700 to form a fixed array ACF. The ACF samples were bonded between ITO glass and flexible printed circuit. ITO glass used is 0.7 mm thick with a surface resistance of 15 ohm/square. The flexible printed circuit comprises copper electrodes of 20 μm width and 8 μm height on a polyimide film of 38 μm thickness and 30 μm spacing between electrodes. Bonding was conducted at 175-195° C. for 7 second with a bonding pressure of 4 MPa.

### EXAMPLE 2

### Effect of Particle Surface Treatment on Contact Resistance

Four 12 μm ACF samples were prepared using commercially available non-spiky Au conductive particles and spiky Au conductive particles. One set of samples was treated with the coupling agent described in Example 1. The other set was not. The particle densities of these ACFs are in the range of 6,000 pcs/mm². The particle diameter was 3.2 μm and they were embedded to a depth of about 2.2 μm such that about 1 μm of the surface was exposed. After bonding, contact resistance was measured via two point probe method using Keithley 2400 Sourcemeter and shown in Table 1 below. There is no observable difference on contact resistance due to particle type or particles surface treatment. It is evident that the surface treatment did not cause any detrimental effect on the contact conductivity or resistivity of the bonded electrodes.

TABLE 1
Effect of Particle Type and Surface
Treatment on Contact Resistance

| | Contact Resistance |
|---|---|
| Particle Type | (ohm/electrode) |
| Non-spiky Particle | 2.4 ± 0.1 |
| Surface-treated Non-spiky Particle | 2.3 ± 0.1 |
| Spiky Particle | 2.3 ± 0.1 |
| Surface-treated Spiky Particle | 2.3 ± 0.1 |

### EXAMPLE 3

### Effect of Particle Surface Treatment on Insulation Resistance

Table 2 shows the effect of particle surface treatment on insulation resistance. ACF samples were prepared using an adhesive of about 12 μm thickness and spiky Au particles with or without surface treatment as described in Example 1. These particles were pre-baked at 80° C. for 16 hours before being coated onto the adhesive film. Constant voltage of 25 volts was applied to these bonded samples to measure insulation resistance of the non-contact area using an Agilent 4339B High Resistance Meter. The results are shown in Table 2.

From Table 2, insulation resistance of bonded ACF samples is in the same order of magnitude for both ACF's with or without surface-treated particles. There was no observable effect of particle surface treatment on insulation resistance even after the samples were aged 366 hours at 85° C. and 85% RH.

TABLE 2
Effect of Particle Surface Treatment on Insulation Resistance

Insulation Resistance (ohm)

| 85° C., 85% RH | ACF with Non- | ACF with Surface- |
|---|---|---|
| aging time | treated Particles | treated Particles |
| 0 hour | 1.6E+11 | 2.3E+11 |
| 366 hour | 7.0E+10 | 8.5E+10 |
| 500 hour | 9.0E+10 | 4.0E+10 |

### EXAMPLE 4

### Effect of Surface Treatment on Particle Capture Rate

ACF samples were prepared for the study of particle capture rate at different bonding temperatures of 175° C. and 195° C. as described in Example 1 using a spiky Au particles and an adhesive layer of 11 μm thickness. Table 3 shows that there is no observable effect of surface treatment on particle capture rate at both bonding temperatures.

TABLE 3
Effect of Particle Surface Treatment on Particle Capture Rate
Particle Capture Rate (%)

| Bonding | ACF with non- | ACF with surface |
|---|---|---|
| Temperature (° C.) | treated particles | treated Particles |
| 175 | 47.8% | 49.2% |
| 195 | 50.6% | 47.7% |

### EXAMPLE 5

### Probability of Short Circuit in the X-Y plane

The probability of short circuit in the X-Y plane is one of the most important selection criteria of ACF products in high density interconnects. Agglomeration of conductive particles is believed to be one of the most important mechanisms contributing to the undesirable short circuit. The probability of short circuit of bonded ACF samples was evaluated using electrode pairs of narrow spacing.

ACF samples were prepared as described in Example 1 using an adhesive layer of 12 μm thickness and bonded between test copper electrodes and patterned ITO electrodes at 175° C. and 4 MPa for 8 seconds. The bonding spaces between neighboring copper and ITO electrodes were varied from 1 to 8 μm. The results are shown in Tables 4 and 5.

TABLE 4
Effect of Surface Treatment on Probability of Short Circuit.

| ACF Thickness | ACF with Non- | ACF with Surface- |
|---|---|---|
| (μm) | treated Spiky Particles | treated Spiky Particles |
| 12 | 2.4% (1/41) | 0% (0/63) |

Spacing of electrode pairs: 3~8 μm

TABLE 5
Effect of Surface Treatment on Probability of Short Circuit.

| | Total | Spacing | Spacing |
|---|---|---|---|
| | Short % | 1 μm | 3 μm |
| Non-treated spiky particle | 3 | 2 | 1 |
| Treated spiky particle | 2 | 2 | 0 |

Spacing of electrode pairs: 1~3 μm

As it can be seen from Table 4, the fixed array ACFs prepared with untreated spiky particles yields 2.4% of short circuit in the electrode pairs in the X-Y plane. In contrast, the ACF with surface-treated spiky particles yields 0% of short circuit, a significant improvement in reduction of the undesirable short when the electrode spacing is in the 3-8 μm range.

As shown in Table 5, a significant reduction of number shorts in the X-Y plane also observed when the electrode spacing was reduced to 3 μm. All electrode pairs bonded with a spacing of less than 3 μm were short since the particle size of the conductive particles used in the ACF is 3 μm.

Not to be bound by theory, it is believed that the coupling agent reacted or adsorbed on the conductive particles significantly improves the dispersibility of the particles and reduces the probability of particle aggregation or clustering in the adhesive during the high temperature and high pressure bonding process. As a result, the probability of short circuit in the X-Y plane was significantly reduced. The effect of surface treatment on the particle dispersion stability is also evident from the rate of particle sedimentation in a solvent such as IPA in a test tube. The untreated particles settled down to the bottom of the test tube almost instantaneously after they were added into the solvent. In contrast, the surface treated particles are quite stable in the solvent and the mixture remains cloudy in the test tube for more than 10 minutes. The significant improvement in dispersion stability of the treated particles in the adhesive layer after bonding was also confirmed by microscope.

90° peeling force measurements by Instron at a speed of 50 mm/min were also conducted on these ACF bonded samples. No observable effect of the surface treatment on peeling force performance before and after 500 hour HHHT (high temperature high humidity) aging at 85° C., 85% RH was found.

According to above descriptions, drawings and examples, this invention discloses an anisotropic conductive film (ACF) that includes a plurality of electrically conductive surface treated particles disposed in predefined non-random particle locations as a non-random array in or on an adhesive layer wherein the non-random particle locations corresponding to a plurality of predefined microcavity locations of an array of microcavities for carrying and transferring the electrically conductive particles to the adhesive layer. The conductive particles are transferred to an adhesive layer. Alternately this invention further discloses an anisotropic conductive film (ACF) that includes an array of microcavities, surrounded by an electrically conductive shell, and filled with a deformable core material for embodiment that includes deformable conductive particles having a conductive shell and a core. Typically, no transfer operation is necessary. In this case, the microcavity array is formed on an adhesive layer. Specifically, the process is carried out by directly coating an adhesive over the microcavity array filled with conductive particles, preferably with a deformable core and a conductive shell. Alternately, the microcavity may also be formed without being coated with an adhesive layer. The coated product could be used as the finished ACF product or preferably be laminated again with a release substrate. No transfer is need in this case. Furthermore, the ACF can be formed by particles that are prepared in situ on the microcavity, by metalizing the microcavity shell, filling a deformable material.

Different kinds of embodiments can be implemented for either the above types of ACF and the electronic devices implemented with the ACFs disclosed in this invention. In a specific embodiment, the electrically conductive particle or microcavity having a diameter or depth in a range between about one to about one hundred micrometers. In another preferred embodiment, the electrically conductive particle or microcavity having a diameter or depth in a range between about two to about ten micrometers. In another preferred embodiment, the electrically conductive particle or microcavity having a diameter or depth with a standard deviation of less than about 10%. In another preferred embodiment, the electrically conductive particle or microcavity has a diameter or depth with a standard deviation of less than about 5%. In another preferred embodiment, the adhesive layer comprises a thermoplastic, thermoset, or their precursors.

In addition to the above embodiment, this invention further discloses an electronic device with electronic components connected with an ACF of this invention wherein the ACF has non-random surface treated conductive particle array arranged according to one, or a combination of more than one, of the processing methods, as described above. In a particular embodiment, the electronic device comprises a display device. In another embodiment, the electronic device comprises a semiconductor chip. In another embodiment, the electronic device comprises a printed circuit board with printed wire. In another preferred embodiment, the electronic device comprises a flexible printed circuit board with printed wire.

Having described the invention in detail and by reference to specific embodiments thereof, it will be apparent that numerous variations and modifications are possible without departing from the scope of the invention as defined by the following claims.

What is claimed is:

1. An anisotropic conductive film (ACF) comprising: (a) an adhesive layer having a substantially uniform thickness; and (b) a plurality of conductive particles individually adhered to the adhesive layer, wherein the conductive particles are coated with a coupling agent and the plurality of conductive particles are arranged in a non-random array of particle sites.

2. The ACF of claim 1 wherein at least a portion of the conductive particles are only partially embedded in the adhesive layer.

3. The ACF of claim 1 wherein the coupling agent is present on the surface of the conductive particle in an amount of about 5 to 100% surface coverage.

4. The ACF of claim 1 wherein the coupling agent is present on the surface of the conductive particle in an amount of about 20% to 100% of surface coverage.

5. The ACF of claim 1 wherein the coupling agent is present on the surface of the conductive particle in an amount of about 50% to 100% of surface coverage.

6. The ACF of claim 1 wherein the particle sites are arranged in an array having a pitch of about 3 to 30 μm in the X and/or Y direction.

7. The ACF of claim 1 wherein the particle sites are arranged in an array having a pitch of about 4 to 12 μm in the X and/or Y direction.

8. The ACF of claim 1 wherein a substantial proportion of the conductive particle sites have no more than a pre-determined maximum number of particles at each particle site.

9. The ACF of claim 8 wherein a substantial proportion of the particle sites having no more than one conductive particle at each particle site.

10. The ACF of claim 1 wherein the conductive particle includes a layer of a metal, or with an intermetallic compound, or with an interpenetrating metal compound.

11. The ACF of claim 1 wherein the coupling agent is a silane coupling agent.

12. The ACF of claim 11 wherein the coupling agent is bonded to the particle by means of a sulfur bond.

13. The ACF of claim 12 wherein the coupling agent includes a thiol group, a disulfide group or a tetrasulfide group.

14. The ACF of claim 2 wherein less than about three-fourths of the particle diameter is embedded in the adhesive layer.

15. The ACF of claim 1 wherein the adhesive includes an epoxy resin.

16. The ACF of claim 14 wherein less than about two-thirds of the particle diameter is embedded in the adhesive layer.

17. The ACF of claim 16 wherein about one-half to two-thirds of the particle diameter is embedded in the adhesive layer.

18. The ACF of claim 1 wherein an electronic device contacts the conductive particles on the surface of the adhesive layer.

19. The ACF of claim 1 wherein the electronic device is an integrated circuit or a printed circuit.

20. The ACF of claim 1 wherein the adhesive layer is about 5 to 35 μm thick.

21. The ACF of claim 1 wherein the adhesive layer is about 10 to 20 μm thick.

22. An anisotropic conductive film (ACF) comprising: (a) an adhesive layer having a substantially uniform thickness; and (b) a plurality of conductive particles individually adhered to the adhesive layer, wherein at least a portion of the conductive particles are only partially embedded in the adhesive layer and are coated with a coupling agent and the plurality of conductive particles are arranged in a non-random array of particle sites.

23. The ACF of claim 22 wherein the coupling agent is present on the surface of the conductive particle in an amount of about 5 to 100% surface coverage.

24. The ACF of claim 23 wherein the coupling agent is present on the surface of the conductive particle in an amount of about 20% to 100% of surface coverage.

25. The ACF of claim 24 wherein the coupling agent is present on the surface of the conductive particle in an amount of about 50% to 100% of surface coverage.

26. The ACF of claim 22 wherein the particle sites are arranged in an array having a pitch of about 3 to 30 μm in the X and/or Y direction.

27. The ACF of claim 25 wherein the particle sites are arranged in an array having a pitch of about 4 to 12 μm in the X and/or Y direction.

28. The ACF of claim 22 wherein a substantial proportion of the conductive particle sites have no more than a pre-determined maximum number of particles at each particle site.

29. The ACF of claim 28 wherein a substantial proportion of the particle sites having no more than one conductive particle at each particle site.

30. The ACF of claim 22 wherein the conductive particle includes a layer of a metal, or with an intermetallic compound, or with an interpenetrating metal compound.

31. The ACF of claim 25 wherein the coupling agent is a silane coupling agent.

32. The ACF of claim 31 wherein the coupling agent is bonded to the particle by means of a sulfur bond.

33. The ACF of claim 32 wherein the coupling agent includes a thiol group, a disulfide group or a tetrasulfide group.

34. The ACF of claim 33 wherein less than about three-fourths of the particle diameter is embedded in the adhesive layer.

35. The ACF of claim 21 wherein the adhesive includes an epoxy resin.

36. The ACF of claim 34 wherein less than about two-thirds of the particle diameter is embedded in the adhesive layer.

37. The ACF of claim 36 wherein about one-half to two-thirds of the particle diameter is embedded in the adhesive layer.

38. The ACF of claim 22 wherein an electronic device contacts the conductive particles on the surface of the adhesive layer.

39. The ACF of claim 38 wherein the electronic device is an integrated circuit or a printed circuit.

40. The ACF of claim 22 wherein the adhesive layer is about 5 to 35 μm thick.

41. The ACF of claim 40 wherein the adhesive layer is about 10 to 20 μm thick.

42. An electronic device in electric contact with the ACF of claim 1.

43. The electronic device of claim 42 wherein the device is printed circuit, an integrated circuit, a display device, photovoltaic cell or module or the like.
